(19) United States
(12) Patent Application Publication
(10) Pub. No.: US 2001/0006099 A1
(43) Pub. Date: Jul. 5, 2001

(54) Injection molding screw for metals

(76) Inventors: Yuji Hayashi, Nagano-ken (JP); Mamoru Miyagawa, Nagano-ken (JP)

Correspondence Address: WEINGARTEN, SCHURGIN, GAGNEBIN & HAYES LLP, Ten Post Office Square, Boston, MA, 02109, US

(21) Appl. No.: 09/740,629

(22) Filed: Dec. 19, 2000

(30) Foreign Application Priority Data
Dec. 28, 1999 (JP) 11-375,383

(51) Int. Cl. B22D 17/10; A21C 1/06

(52) U.S. Cl. 164/312; 366/79

(57) ABSTRACT

An injection molding screw is provided to prevent the materials from being left, and reduce the friction of the screw rotation and sliding only by limiting the end position of the screw flight to a certain position according to the position of the feeding opening in the heating cylinder. A screw 16 is rotationally and movably provided in a heating cylinder 10 having a nozzle at a tip end thereof. Granular metals fed from a feeding opening 13 at the rear of the heating cylinder are transferred forward by the screw rotation and melted. Melted metals metered in the end of the heating cylinder 10 are injected from the nozzle 11 by the forward movement of the screw. A rear end 19a of a screw flight 19 formed around the axis of the screw 16 is positioned below the rear edge of the feeding opening 13 at the rearmost position of the screw. At the foremost position of the screw, the rear end 19a is positioned in front of the feeding opening 13 in order to close the feeding opening 13 by the rear portion 18a of the axis 18.

### BACKGROUND OF THE INVENTION

1. Field of the invention

The present invention relates to an injection molding screw for metals which is used for melting and injection molding non-ferrous metals including zinc, magnesium or the alloys thereof having a low melting point.

2. Detailed Description of the Related Art

The molding of non-ferrous metals including lead, zinc, magnesium and tin having a low melting point or the alloys thereof used to be conducted by a die-casting. By employing injection molding methods similar to that for plastic materials, the molding process is being simplified and the precision of the molding is being improved.

Notwithstanding the above, a difference in melting process between plastics and metals causes some problems.

FIGS. 3 and 4 show an apparatus to be used for injection molding. The apparatus has a nozzle 2 on the end, and a heating cylinder 1 with a feeding opening 3 on the rear thereof. The heating cylinder 1 contains a screw 7 for injection so as to be rotational and movable thereinside. The screw 7 is provided with a conical tip end 4 and a screw flight 6 around an axis 5 thereof.

In the injection molding of a plastic material, the plastic material is melted by a shear heat generated by the rotation of screw (plastication). Once injecting the metered melting plastic material by the fore end portion of the heating cylinder through forwarding the screw, during the plastication by the rotation of the screw, the plastics will be metered through the backing of the screw by the pressure from the stored materials.

Therefore, for the injection screw for plastics, the end 6a of the screw flight 6 is needed to be positioned below rear edge 3a of the feeding opening 3 at the foremost position of the screw, as shown in FIG. 3. In this configuration, a screw groove 6b is needed to be always formed facing the feeding opening 3.

On the other hand, the metals are melted with external heat. The melted metals in liquid phase have low viscosity as differed from plastics. Therefore, the metals are transferred to the fore end of the heating cylinder by the rotation of the screw. However, since they cannot generate enough pressure to move the screw backward, the metering is performed by backing the screw mechanically and forcedly. The materials are transferred into the front of the heating cylinder by the rotation of the screw at the rearmost position of the screw.

In the injection molding of the metals as stated above, when the screw for injection molding of plastics is employed, as shown in FIG. 4, at the rearmost position of the screw, the rear end 6a of the screw flight 6 will be positioned behind the feeding opening 3. At the same time, the metals left in the screw groove 6b will be transferred and stay behind the feeding opening 3.

The materials left therein will be forwarded by the rotation of the screw. Since there is the feeding opening 3 before the left materials when the screw is in the rearmost position, the metal materials are additionally fed into the screw groove below the feeding opening 3. Therefore, the left materials have a tendency to stay therein, which impairs the screw rotation or sliding.

When the screw with the screw groove 6b always facing the feeding opening 3 is employed, the materials are ready for being transferred into the heating cylinder by the screw rotation in regardless of screw position. Hence, when the screw is rotated for a purpose besides the plastification, the screw groove 6b is fed and may be congested with the materials from the feeding opening 3. To prevent the congestion, feeding the materials into the feeding opening 3 is temporarily stopped, which causes inconvenience.

### SUMMARY OF THE INVENTION

The present invention is aimed to solve the above-mentioned problems. An object of the present invention is to provide an injection screw for metals which allows to prevent the materials from being left, and reduce the friction of the screw rotation and sliding only by limiting the end position of the screw flight to a certain position according to the position of the feeding opening in the heating cylinder.

In order to achieve the above-mentioned object, the present invention provides an injection molding screw for metals, which is rotationally and movably provided in a heating cylinder having a nozzle at a tip end thereof, for transferring granular metals fed thereinside from a feeding opening at the rear of the heating cylinder while melting the metals, and for injecting the melted metals metered in the fore end of the heating cylinder from the nozzle by the forward movement of the screw, wherein a screw flight is formed around an axis of the screw, of which rear end is positioned below a rear edge of the feeding opening at the rearmost position of the screw in the heating cylinder, and wherein at the foremost position of the screw, the rear end thereof is positioned in front of the feeding opening in order to close the feeding opening by a rear portion of the axis.

With the screw as mentioned above, as the feeding opening is closed along with the forward movement of the screw by the axis, the congestion of the metals in the screw grooves at the end of the screw by automatically controlling the feeding of the materials when the injection starts. Thereby, the friction of the screw rotation and sliding decreases. The metals will be melted injected steadily and the quality of the molded products will be improved.

The nature, principle, and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a longitudinal sectional side view illustrating an injection apparatus having an injection molding screw for metals according to the present invention at the rearmost position of the screw;

FIG. 2 is a longitudinal sectional side view illustrating the injection apparatus at the foremost position of the screw;

FIG. 3 is a longitudinal sectional side view illustrating an injection apparatus having a conventional injection molding screw at the foremost position of the screw; and

FIG. 4 is a longitudinal sectional side view illustrating the conventional injection apparatus at the rearmost position of the screw.

### PREFERRED EMBODIMENTS OF THE INVENTION

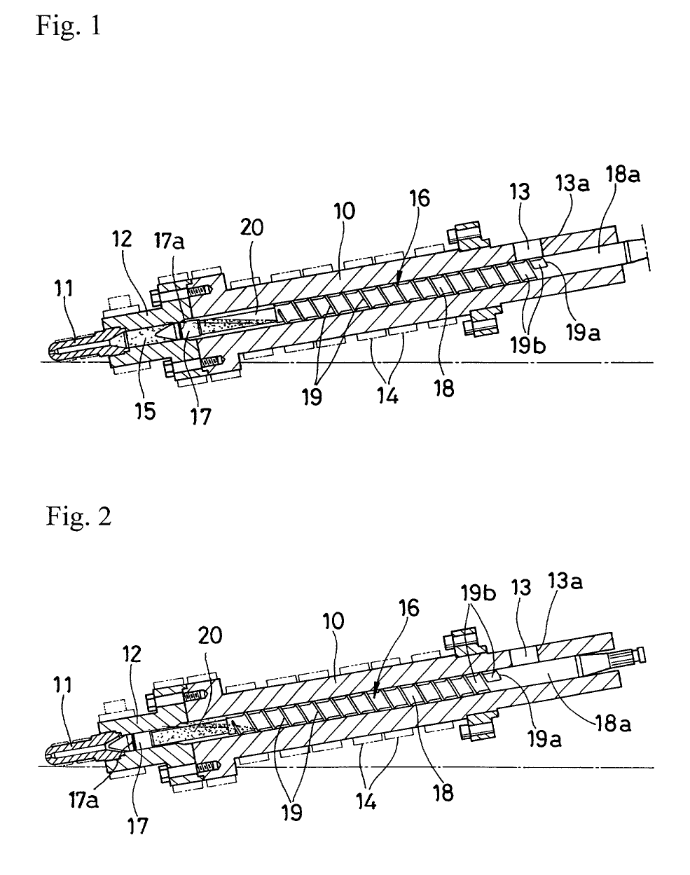

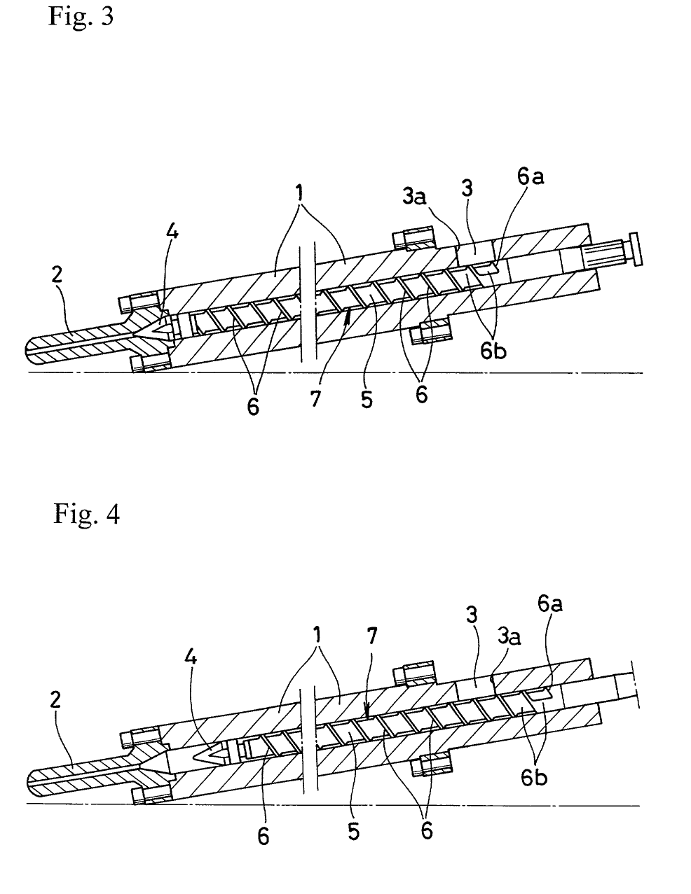

FIGS. 1 and 2 show an embodiment of the injection apparatus of metals which employs the injection screw according to the present invention.

In figures, a reference numeral 10 denotes a heating cylinder which has a fore end member 12. On the fore end surface thereof, a nozzle member 11 is screwed. The heating cylinder 10 has a feeding opening 13 for granular metals at the rear portion thereof. Band heaters 14 are mounted at regular intervals around the nozzle member 11 and the heating cylinder 10 from the fore end member 12 to the feeding opening 13.

The diameter of the fore end member 12 communicating with the nozzle member 11 is smaller than the internal diameter of the heating cylinder 10 by 8-15%. A metering chamber 15 of the required length is formed in the fore end member of the heating cylinder 10.

In the heating cylinder 10, the injection screw 16 is provided rotationally and movably. The fore end of the injection screw 16 is formed into a plunger 17. The diameter of the plunger 17 is large enough to keep a clearance where the plunger 17 enters freely into the metering chamber 15. The plunger 17 has the conical surface at the fore end thereof which fits the funnel-shaped end surface of the metering chamber 15. In the circumference thereof a seal ring 17a is provided to prevent the materials from flowing backward from the clearance at injection. For the seal ring 17a, a piston ring of special steel with heat proof can be applied.

Around an axis 18 of the screw 16, screw flights 19 are formed. The external diameter of the screw flights 19 is almost equal to the internal diameter of the heating cylinder 10. They are formed on the axis of the same diameter at a constant pitch. The rear end 19a of the screw flight 19, as shown in FIG. 1, at the rearmost position of the screw in the heating cylinder 10, is positioned below the rear edge 13a of the feeding opening 13. Also as shown in FIG. 2, at the foremost position of the screw, the rear end 19a is positioned in front of the feeding opening 13 in order to close the feeding opening 13 by the rear portion 18a of the axis 18. The portion adjacent to the plunger 17 does not have screw flights for the required length to form a reservoir 20 to store the melted metals.

The injection apparatus in the construction stated above is used by being installed on a table with an inclination of an angle from 3 to 10 degrees and positioning the feeding opening 13 higher than the nozzle 11. Thereby, it allows the metals in liquid phase in the heating cylinder 10 to freely flow down and be stored into the fore end portion. The metals are melted by the band heaters 14 around the heating cylinder 10 (for example, the temperature for Mg is 610° C. or higher).

In the injection apparatus, the rear end 19a of the screw flights 19 is below the rear edge 13a of the feeding opening 13 and the screw groove 19b faces the feeding opening 13 at the rearmost position of the screw. After the screw 16 starts forwarding, the metals will not be fed additionally. During transferring the materials by the screw rotation, they will be melted with external heat. The melted materials will be stored in the fore end of the heating cylinder 10.

Therefore, the granular metals shortly stay in the screw groove 19b. As the result of it, the friction of the rotation and sliding caused from the congestion of the materials will be reduced which allows the screw 16 to move smoothly. Furthermore, the rotation torque of the screw 16 may become small according to the reduction of the friction of the rotation, where the motor power for driving the apparatus may be small.

After the screw 16 moves forward to the foremost position as shown in FIG. 2 and the injection of the melted metals stored in the metering chamber 15 is completed, the screw 16 moves to the rearmost position as shown in FIG. 1. The screw 16 does not rotate during moving forward and backward. When the screw 16 returns near the rearmost position, it starts rotating to feed the materials. The screw 16 rotates while it is in the rearmost position. The frequency of screw rotation defines the amount of the materials to be fed.

For some reasons, also it is necessary to rotate the screw 16 until the screw 16 reaches at the foremost or the rearmost position, the materials will not be fed by the screw rotation. Therefore, an excess feeding will be prevented. Thereby, the congestion of the materials in the screw grooves of the end of the screw is prevented so that the friction of the rotation and sliding of the screw will be reduced. As the result of it, the melting and injection of the metals will be steady and the quality of the molded products will be improved.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. An injection molding screw for metals, which is rotationally and movably provided in a heating cylinder having a nozzle at an end thereof, for transferring granular metals fed thereinside from a feeding opening at the rear of the heating cylinder while melting the metals, and for injecting the melted metals metered in the fore end of the heating cylinder from the nozzle by the forward movement of the screw, wherein a screw flight is formed around an axis of the screw, of which rear end is positioned below a rear edge of the feeding opening at the rearmost position of the screw in the heating cylinder, and wherein at the foremost position of the screw, the rear end thereof is positioned in front of the feeding opening in order to close the feeding opening by a rear portion of the axis.
